(19) United States
(12) Patent Application Publication
(10) Pub. No.: US 2011/0270432 A1
(43) Pub. Date: Nov. 3, 2011

(54) SCALABLE MANUFACTURING ASSEMBLY VERIFICATION SYSTEM

(75) Inventors: Michael D. Carpenter, Rochester Hills, MI (US); Phillip W. Lewis, JR., Sterling Heights, MI (US); Timothy McGuire, Macomb, MI (US); David P. Vitale, Clarkston, MI (US); Phillip W. Stevens, Saginaw, MI (US); Michael J. Durak, Clinton Township, MI (US)

(73) Assignee: GENERAL MOTORS CORPORATION@@GM GLOBAL TECHNOLOGY OPERATIONS, INC., Detroit, MI (US)

(21) Appl. No.: 12/772,618

(22) Filed: May 3, 2010

(51) Int. Cl. G06F 17/00

(52) U.S. Cl. 700/110

(57) ABSTRACT

A scalable manufacturing assembly verification system for use in a manufacturing facility to verify assembly of a product, the system comprising assembly process work stations and assembly verification system stations. The assembly process work stations are each configured to provide at least one device configured to aid in assembly of the product. The assembly verification system stations are each located within a different one of the assembly process work stations, with each of the assembly verification system stations including a computing device in communication with the device, and with each computing device including a respective set of business rules corresponding to the assembly process work station within which the computing device is located, wherein each set of the business rules provides assembly verification for the device to error check assembly of the product with the device.

### BACKGROUND OF INVENTION

The present invention relates generally to manufacturing assembly systems and more particularly to assembly verification systems employed during manufacturing assembly.

Significant investment may be required to implement electronic verification of assembly for some types of assembly plants—for example, assembly of automotive vehicles. In the past, integrated solutions have been employed where a centralized controller with a plant floor field-bus that branches out to a node at every assembly process work station is employed. The nodes at the ends of the branches are not smart devices capable of execution on their own, requiring control from the centralized controller to operate. Due to the centralized controller architecture, these systems are not scalable on an individual work station basis.

For example, one can choose to have error proofing (also called assembly verification) within a geographic area of the assembly plant, but does not have the resolution to decide to have error proofing on a per operator station basis. The cost to install this type of assembly error proofing necessitates the installation of an infrastructure within every operator workstation in the particular geographic area of the assembly plant, regardless if it is used at each work station or not. Consequently, these systems rely on an infrastructure investment that at many manufacturing facilities far exceeds the desired investment cost on a per operator workstation basis. The investment concern is particularly acute in more-price sensitive low-labor cost regions, where the quantity of electronic stations at an assembly plant may be small, making the total investment on a per workstation basis cost prohibitive. In addition, such error proofing systems have limited ability to be expanded for growth in the facility without excessive additional cost being incurred. Accordingly, for many assembly plants in low-labor cost regions, electronic error proofing may not be implemented, with secondary manual inspection used instead of error proofing systems.

### SUMMARY OF INVENTION

An embodiment contemplates a scalable manufacturing assembly verification system for use in a manufacturing facility to verify assembly of a product, the system comprising assembly process work stations and assembly verification system stations. The assembly process work stations are each configured to provide at least one device configured to aid in assembly of the product. The assembly verification system stations are each located within a different one of the assembly process work stations, with each of the assembly verification system stations including a computing device in communication with the device, and with each computing device including a respective set of business rules corresponding to the assembly process work station within which the computing device is located, wherein each set of the business rules provides assembly verification for the device to error check assembly of the product with the device. Each of the computing devices can execute its respective business rules independently of the other computing devices executing their business rules.

An advantage of an embodiment is that assembly verification systems within manufacturing facilities are created at a much lower cost, while maintaining or improving assembly build quality. In addition, the manufacturing assembly verification system allows for ease of scaling the system to build a smaller or a larger integrated system of distributed assembly verification system stations. The scaling also includes allowing one to choose the appropriate balance between cost and automation in determining whether and what size each of the levels of the system may be introduced into a manufacturing facility, with changes in scale achievable as the business at the manufacturing facility changes over time.

### BRIEF DESCRIPTION OF DRAWINGS

FIG. 1 is a schematic drawing of a scalable manufacturing assembly verification system.

FIG. 2 is a schematic drawing of the scalable manufacturing assembly verification system with a different number of subcomponents installed in the system.

FIG. 3 is a schematic drawing of an assembly process work station that is employed in either of the verification systems of FIGS. 1 and 2.

### DETAILED DESCRIPTION

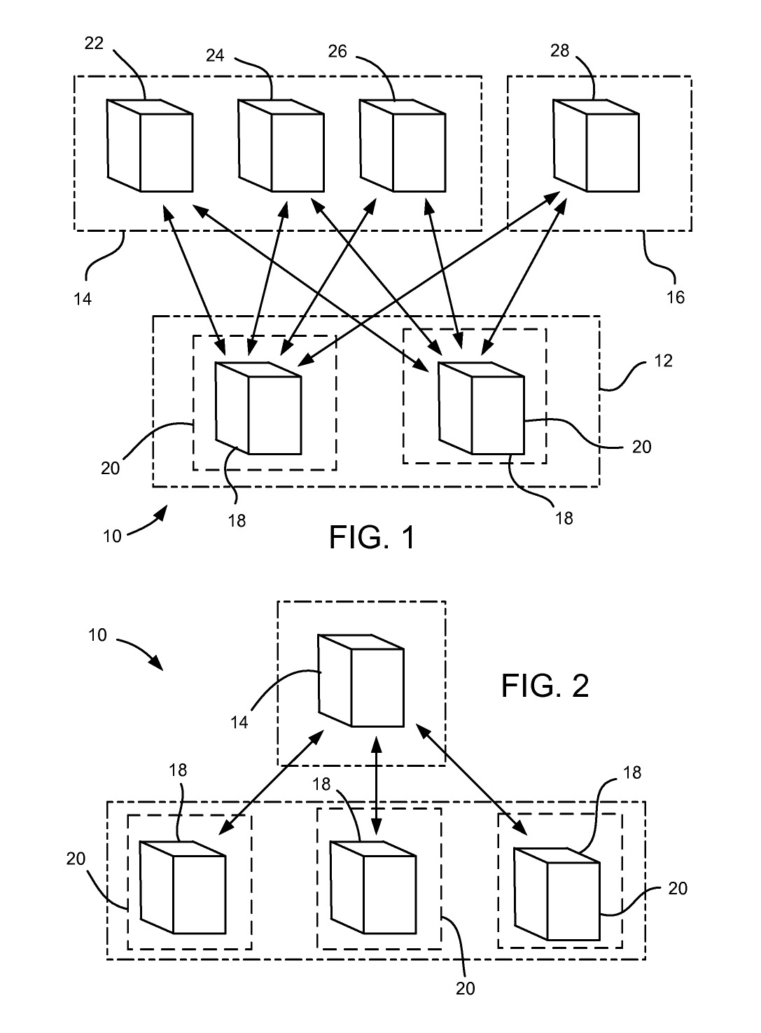

Referring to FIG. 1, a scalable manufacturing assembly verification system, indicated generally at 10, is shown. The system 10 includes a first level 12 of assembly verification architecture and may also include a second level 14 or a third level 16 or both additional levels of assembly verification architecture. The levels of verification architecture are different levels of communication and tracking of the assembly verification process within the manufacturing environment and are indicated by phantom lines in the figures.

The first level 12 includes multiple assembly verification system stations 18, each located at a different assembly process work station 20, indicated by dashed lines in the figures. The number of assembly verification system stations 18 are based on the number of work stations 20 where it is desired to have assembly verification and it is cost effective to do so. This may be only a few assembly verification system stations 18 or it may be in the hundreds at a larger manufacturing facility. Each assembly process work station 20 is a location at a manufacturing facility where some assembly of the product, which may be a vehicle, takes place. For work stations 20 in the assembly process where assembly verification is important (i.e., where it is important to assure the assembly occurred properly), an assembly verification system station 19 is preferably operating.

Each assembly verification system station 18 is configurable via a human-machine interface (HMI). The HMI may be a keyboard, mouse, touch screen, some other means of human input/output to the system station 18 or a combination of these. The system stations 18 at the first level may generally operate without systems connections to other levels since the information and instructions for verification to prevent/track errors (business rules) are contained in the system stations 18 themselves. The first level system stations 18 may operate based on reading a product ID, such as a vehicle ID obtained from a barcode on the product being assembled.

The second level 14 is located in the manufacturing facility and communicates with the first level system stations 18 through network communications (indicated by arrows in FIG. 1). These may be wired or wireless networks.

The second level 14 may include a global standard inspection process (GSIP) system 22, which is a quality reporting system that is in communication with each of the system stations 18. The GSIP system 22 may track potential vehicle defects for various assembly verification operations to better error proof the assembly operations. For example, the system stations 18 may report a current status of assembly verification actions, report faults to the GSIP system 22 for historical reporting, or submit vehicle records for storage in a database.

The second level 14 may also include a global enterprise production information control system (GEPICS) 24, which is a vehicle order data system that is in communication with the system stations 18. This system 24 may include manifest information, vehicle sequencing information and part scan traceability. The system stations 18 can obtain the build sequence and vehicle option data directly from GEPICS 24, if so desired, with the system stations 18 confirming vehicle sequencing at the work stations 20. Alternatively, the system stations 18 may provide offline sequencing, even with GEPICS 24 communication available, since each system station 18 contains the work rules for its own work station 20.

The second level 14 may additionally include a global production monitoring and control (GPMC) system 26, which is a real time plant monitoring system that is in communication with the system stations 18. The second level systems may allow some of the processes (e.g., vehicle identification and quality reporting) to be further automated and may also allow for automated oversight of part kitting and part sequencing. In addition, the GPMC system 26 may receive reports of assembly verification faults from the system stations 18, or reports from system stations 18 where a work station 20 is holding the assembly line in order to escalate any problems to assure prompt correction.

The third level 16 may include a centralized system 28 having functionality to provide a centralized location for vehicle configuration as well as add visualization capability to determine the status of the assembly verification system stations 18 throughout the manufacturing facility. Having this third level centralized system 28 may make disaster recovery and system configuration tracking more efficient as well.

FIG. 2 illustrates another configuration of the scalable manufacturing assembly verification system 10. In this configuration, the assembly verification system stations 18 at the various assembly process work stations 20 communicate with the second level 14, which has just one system 30. That system may be any one of the GSIP, GEPICS or GMPC systems.

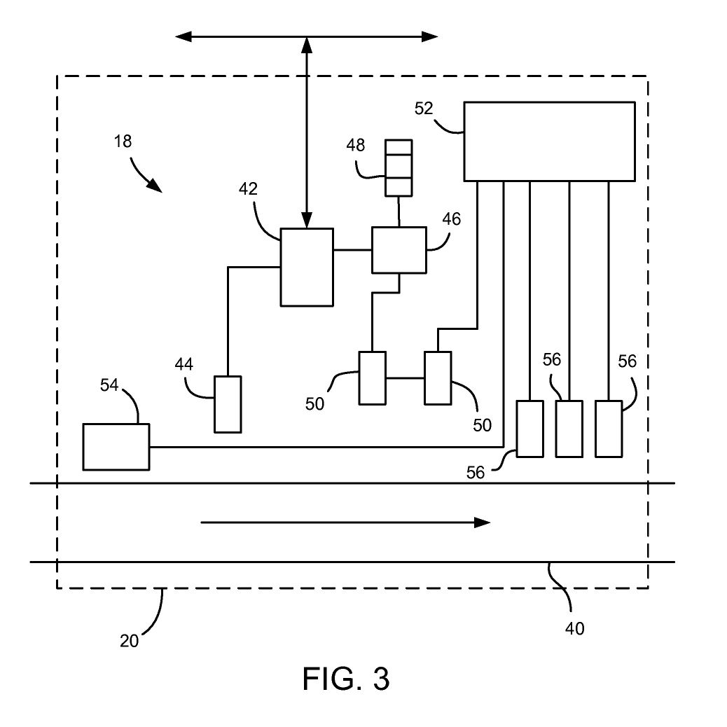

FIG. 3 illustrates an assembly process work station 20 that may be employed in the scalable manufacturing assembly verification systems 10 of FIGS. 1 and 2. The work station 20 may be located along side a conveyor 40 that transports the products to be assembled. One of the assembly verification system stations 18 is located in the work station 20.

This system station 18 may include a computing device 42, such as, for example, a laptop or desktop general purpose computer or a tablet type of computer. The computing device 42 has the functionality to execute the business rules applied to the particular work station 20 independent from the other system stations 18 and independent from the second level systems 14 and the third level system 16. The computing device 42 may operate employing an industrial Windows CE™ based computer running application specific programs that implement the assembly verification business rules.

The business rules are implemented by the computing device 42 and are the rules used to verify the assembly process at that particular work station 20. The business rules may include, for example, verification of assembly of fasteners to the product, verification of proper part picks, verification of part bar code scans, verification of fluid fill volumes or air pressures, verification of dimensional tolerances, verification of station cycle times, verification of operator motion, or any combination of these assembly processes or other assembly processes that occur at the particular work station 20. With the business rules for each system station 18 contained in its respective computing device 42, scalability of the assembly verification is relatively easy and cost effective, with an ability for independent determination as to the desire for a system station 18 at any particular work station 20 being made on a per work station basis.

The computing device 42 may receive input from a manually operated handheld scanner 44, and may communicate with other components via a computer interface 46. The computer interface 46 may communicate with a visual alert device 48 that may employ red, green and yellow lights to indicate the status of the system station 18, and may also include an audio output device that provides alerts to the person performing the assembly at the particular work station 20. The computer interface 46 may also communicate with input/output interface devices 50 and an unmanaged switch 52. The unmanaged switch 52 may, for example, communicate with a fixed scanner 54 that reads bar codes or other information affixed to the products as they travel on the conveyor 40 and with torque controllers 56 that read the torque applied by various tools used during the assembly process being completed at this particular work station 20. All of these devices are operated based on the business rules contained in the computing device 42 at that particular work station 20, with the computing device 42 also verifying the operation of these devices for purposes of error proofing the assembly operations that take place at this work station 20.

The computing device 42 contains the device drivers needed to communicate with the particular components at this work station 20. Again, this allows the assembly verification system stations 18 at each work station to operate independently, thus allowing for ease of scalability of the scalable manufacturing assembly verification system 10.

An example of operation of an assembly process work station 20 includes the fixed scanner 54 reading a bar code on a partially assembled vehicle moving on the conveyor 40. The scanned information is transmitted to the computing device 42, which has the associated vehicle and build data stored therein. This activates the assembly verification. As assembly processes take place at that work station 20, for example a fastener assembly, the applied torque (via a torque controller 56), operator cycle time and part number of the component (read by the hand scanner 44) may be stored in the computing device 42. This information may be used later for reporting purposes to second or third level systems.

The computing device 42 may operate off-line without communication to other devices, on-line with real time network communication with other systems (indicated by the arrows in FIG. 3), and/or near-line with other than real time network communications. Also, this information may be used by the computing device 42 to signal an error should assembly verification (based on the business rules) detect an error. Thus, assembly verification is achieved in a system that is scalable to meet the needs and cost requirements at manufacturing facilities having significantly different requirements.

While certain embodiments of the present invention have been described in detail, those familiar with the art to which this invention relates will recognize various alternative designs and embodiments for practicing the invention as defined by the following claims.

What is claimed is:

1. A scalable manufacturing assembly verification system for use in a manufacturing facility to verify assembly of a product, the system comprising:
a plurality of assembly process work stations, each configured to provide at least one device configured to aid in assembly of the product; and
a plurality of assembly verification system stations, each located within a different one of the assembly process work stations, each of the assembly verification system stations including a computing device in communication with the device, and each computing device including a respective set of business rules corresponding to the assembly process work station within which the computing device is located, wherein each set of the business rules provides assembly verification for the device to error check assembly of the product with the device, each of the computing devices being configured to execute the respective business rules independently of the other computing devices.

2. The scalable manufacturing assembly verification system of claim 1 including a global standard inspection process system in communication with each of the assembly verification system stations, the global standard inspection process system configured to receive a plurality of quality reports from the assembly verification system stations for tracking potential defects in the assembly of the product.

3. The scalable manufacturing assembly verification system of claim 2 including a global enterprise production information control system in communication with each of the assembly verification system stations, the global enterprise production information control system configured to coordinate sequencing information of the product with each of the assembly verification system stations.

4. The scalable manufacturing assembly verification system of claim 3 including a global production monitoring and control system in communication with each of the assembly verification system stations, the global production monitoring and control system configured to receive assembly verification faults from the assembly verification system stations.

5. The scalable manufacturing assembly verification system of claim 1 including a global enterprise production information control system in communication with each of the assembly verification system stations, the global enterprise production information control system configured to coordinate sequencing information of the product with each of the assembly verification system stations.

6. The scalable manufacturing assembly verification system of claim 1 including a global production monitoring and control system in communication with each of the assembly verification system stations, the global production monitoring and control system configured to receive assembly verification faults from the assembly verification system stations.

7. The scalable manufacturing assembly verification system of claim 1 wherein the device is a scanner configured to scan a readable medium on the product, and the computing device is configured to receive an input from the scanner and determine the assembly processes required for the product at the corresponding assembly process work station based on the scan.

8. The scalable manufacturing assembly verification system of claim 1 wherein the device is a torque controller configured to read a torque applied during assembly of the product at the corresponding assembly process work station, and wherein the computing device is configured to receive and store torque information for assembly of the product.

9. The scalable manufacturing assembly verification system of claim 1 including a centralized system in communication with each of the assembly verification system stations, the centralized system configured to provide a visual representation of a status for each of the assembly verification system stations.

10. The scalable manufacturing assembly verification system of claim 1 wherein each of the assembly verification system stations includes a visual alert indicator controlled by the computing device, each of the computing devices configured to provide visual indications of the status of the corresponding assembly process work station by activating different visual indicators on the visual alert indicator.

11. The scalable manufacturing assembly verification system of claim 1 wherein each of the assembly verification system stations includes a human machine interface configured to provide inputs to the computing device by an operator of the corresponding assembly process work station.
